(19) United States
(12) Patent Application Publication
(10) Pub. No.: US 2025/0147324 A1
(43) Pub. Date: May 8, 2025

(54) WEARABLE VIDEO DISPLAY

(71) Applicant: KOPIN CORPORATION, WESTBOROUGH, MA (US)

(72) Inventor: HIDEKI TOMINE, MACHIDA (JP)

(73) Assignee: KOPIN CORPORATION, WESTBOROUGH, MA (US)

(21) Appl. No.: 18/721,525

(22) PCT Filed: Dec. 23, 2021
(86) PCT No.: PCT/JP2021/047804

§ 371 Date: Jan. 13, 2025

(30) Foreign Application Priority Data
Dec. 23, 2021 (WO) PCT/JP2021/047804

(51) Int. Cl. G02B 27/01

(52) U.S. Cl. CPC G02B 27/0176; G02B 2027/0152; G02B 2027/0178

(57) ABSTRACT

The objective of the present invention is to provide a wearable video display device (10) with which the fitting comfort for a user (U) can be improved while suppressing shifting of a display unit (11). The wearable video display device comprises: the display unit (11); a left frame (17) and a right frame (18) which extend in a rearward direction from the display unit and are provided independently of one another; a forehead support portion (26) which accepts a supporting force from a supra-orbital margin of the user's forehead; and a nose support portion (27) that accepts a supporting force from the user's nose. Rear regions of the left frame and the right frame serve as occipital support portions (23, 24) that accept a supporting force from the back of the user's head. The total weight of the wearable video display device is set to 300 gf or less, and the total weight is supported by the forehead support portion, the nose support portion, and the occipital support portions.

### TECHNICAL FIELD

The present invention relates to a wearable video display device that is used by being worn on the head.

### BACKGROUND ART

HMDs (head mounted displays) that can be worn on a user's head to view images have been used in the past. Conventional HMDs are constructed to be firmly fixed such that the HMD does not move relative to the face, to allow images to be viewed satisfactorily. Such a structure is disclosed in patent literature article 1, for example.

Patent literature article 1 discloses a HMD comprising a display unit for displaying a video that can be observed by a user, front pressing portions that come into contact with the forehead of the user, and rear pressing portions that are provided at distal ends of side frames and that come into contact with the back of the head.

### PRIOR ART LITERATURE

### Patent Literature

[Patent literature article 1] Japanese Unexamined Patent Application Publication H11-298826

### SUMMARY OF INVENTION

### Problems to be Resolved by the Invention

In patent literature article 1, in order to prevent the display unit shifting downward due to the weight of the display unit, a pressing force applied to the head by the front pressing portion and the rear pressing portion tends to be strong, and there is thus room for improvement in terms of the fitting comfort.

The present invention has been made in consideration of the above-mentioned points, and the objective thereof is to provide a wearable video display device with which it is possible to improve the fitting comfort for the user, while suppressing shifting of the display unit.

### Means for Overcoming the Problem

A wearable video display device according to an embodiment of the present invention is worn on the head of a user, and comprises a display unit provided with a display element and an eyepiece optical system accommodated in a housing, a left frame and a right frame which extend in a rearward direction from the display unit and are provided independently of one another, a forehead support portion which accepts a supporting force from a supra-orbital margin of the user's forehead, and a nose support portion which accepts a supporting force from the user's nose, characterized in that: rear regions of the left frame and the right frame serve as occipital support portions that accept a supporting force from the back of the user's head; and a total weight of the wearable video display device is set to 300 gf or less, and the total weight is supported by the forehead support portion, the nose support portion, and the occipital support portions.

### Effect of the Invention

According to the present invention, the points that accept supporting forces from the head of the user can be distributed between the forehead support portion, the nose support portion, and the occipital support portions, while keeping the total weight low. This makes it possible to improve the fitting comfort for the user while suppressing shifting of the display unit.

### BRIEF DESCRIPTION OF THE DRAWINGS

FIG. 1 is a schematic oblique view of a wearable video display device according to an embodiment.

FIG. 2 is a plan view of the wearable video display device.

FIG. 3 is a rear view of the wearable video display device.

FIG. 4 is a side view of the wearable video display device in a state when worn by a user.

### MODES OF EMBODYING THE INVENTION

A wearable video display device according to an embodiment will now be described in detail with reference to the accompanying drawings. It should be noted that the invention is not limited to the following embodiment, and can be modified as appropriate within a scope that does not change the gist of the invention. In the following drawings, for the sake of convenience, some components may be omitted. In addition, in the following description, unless otherwise specified, “up,” “down,” “left,” “right,” “front,” and “back” are used relative to directions indicated by the arrows in each drawing (relative to the user wearing the wearable video display device). However, the orientation of each component in the following embodiment is merely an example, and the orientation can be changed to any orientation.

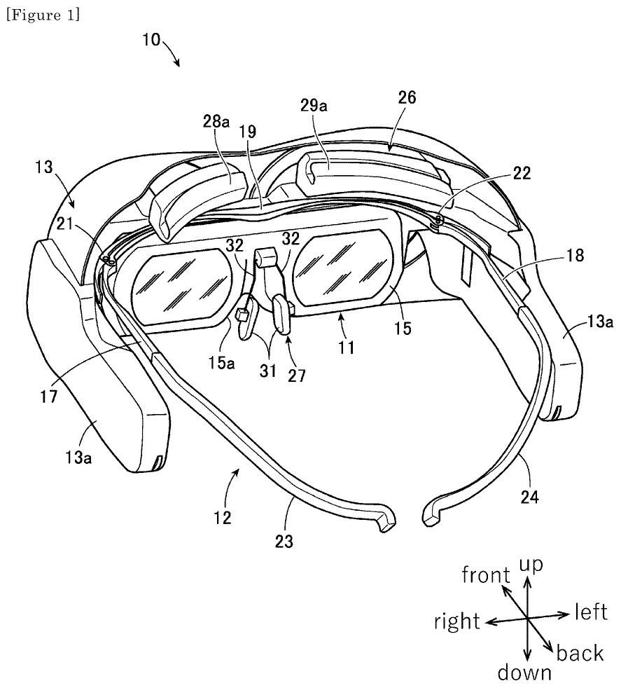

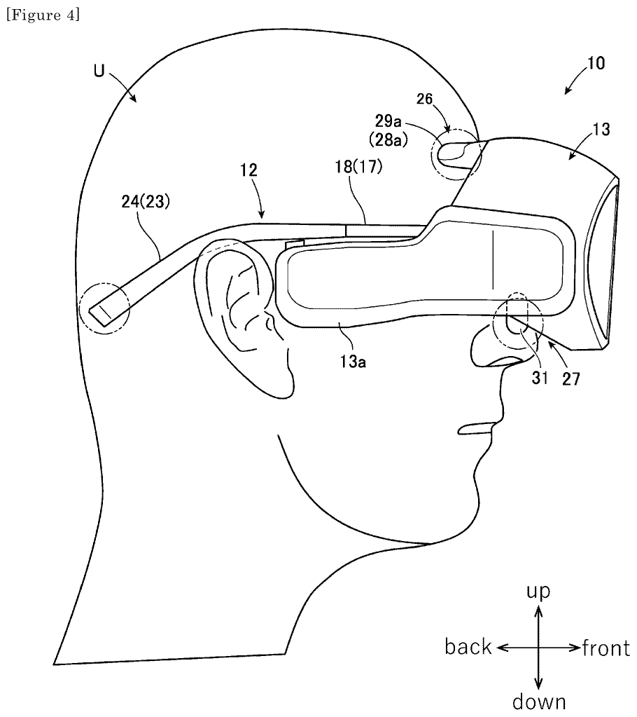

FIG. 1 is a schematic oblique view of a wearable video display device according to the embodiment. As illustrated in FIG. 1, a wearable image display device 10 is a device also known as an HMD (head-mounted display), which is a device that makes it possible for images such as video images to be experienced virtually as images equivalent to those projected on a large screen. The wearable video display device 10 is a look-in type wearable video display device 10 which is used by being worn on the head of a user U (see FIG. 4).

The wearable video display device 10 is configured to include a display unit 11, a frame member 12, and a cover member 13. The cover member 13 has a shape that is open toward the rear and that covers both upper and lower sides and both left and right sides of the display unit 11, and extension regions 13a disposed along a left frame 17 and a right frame 18, discussed hereinafter, are provided on both the left and right sides. Although a detailed description thereof is omitted, the cover member 13 including the extension regions 13a can be provided with a speaker, a battery, and switches, as well as interfaces and ports for connecting various cables.

The display unit 11 is provided with a housing 15 for accommodating eyepiece optical systems and display elements (neither of which are illustrated) provided corresponding to the left and right eyes of the user U. In the present embodiment there is a single housing 15. A lower edge in the center, in the left-right direction, of the housing 15 is formed as a recessed nose notched portion 15a.

High-magnification, compact eyepiece optical systems capable of creating a virtual image having a large FOV (field of view, also referred to as “field of view angle”) from a relatively small display element can be employed as the eyepiece optical systems accommodated in the housing 15. The eyepiece optical systems may, for example, have a folded optical path created by utilizing polarization and reflection, and two or more reflections may be performed in order to create the folded optical path. Further, the eyepiece optical systems can be exemplified by a coaxial eyepiece optical system in which two lenses have optical axes at the same position.

The display elements accommodated in the housing 15 each comprise a display panel having a large field of view angle, for example an OLED (Organic Light Emitting Diode) panel or a micro LED (Light Emitting Diode) panel.

The frame member 12 comprises the left frame 17, the right frame 18, and a front frame 19 connected to a front end side of the right frame 17 and a front end side of the left frame 18. The left frame 17 and the right frame 18 are provided independently of one another and extend toward the rear from the display unit 11. The front frame 19 is mounted on an upper portion of the housing 15 of the display unit 11, and the left frame 17 and the right frame 18 are supported on the housing 15 by means of the front frame 19. This makes it possible to manufacture the frame member 12, including the left frame 17 and the right frame 18, as an integrated body, and to simplify manufacture since a mounting position of the frame member 12 with respect to the display unit 11 is a single point of the front frame 19.

Hinges 21, 22 are provided in parts where a front end side of the left frame 17 and a front end side of the right frame 18 connect to the front frame 19, and the left frame 17 and the right frame 18 can pivot by means of the hinges 21, 22. The left frame 17 and the right frame 18 are formed from a material capable of exhibiting elasticity, as discussed hereinafter, for example a titanium alloy such as β-titanium or nylon resin.

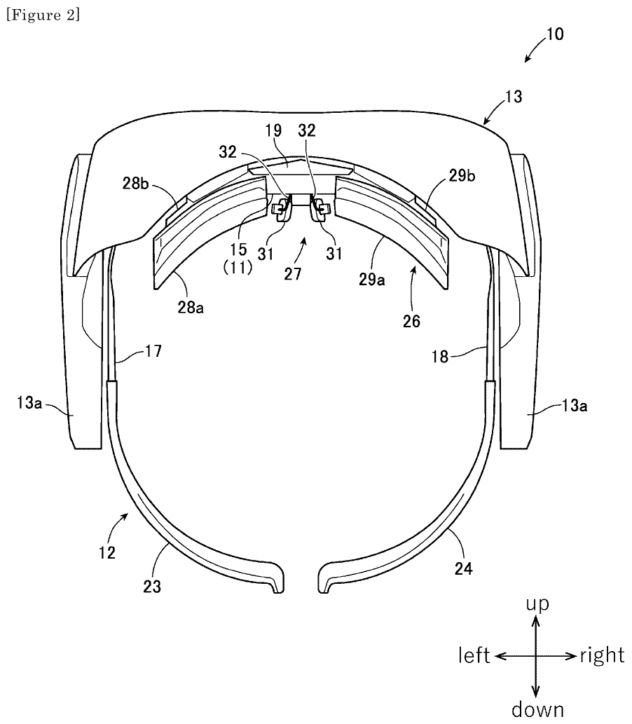

FIG. 2 is a plan view of the wearable video display device according to the embodiment. As illustrated in FIG. 2, a rear region of the left frame 17 and a rear region of the right frame 18 are formed with a curved shape as seen from above, and the rear regions are formed as occipital support portions 23, 24. Rear ends (distal ends) of the occipital support portions 23, 24 are disposed spaced apart from one another with a slight gap therebetween.

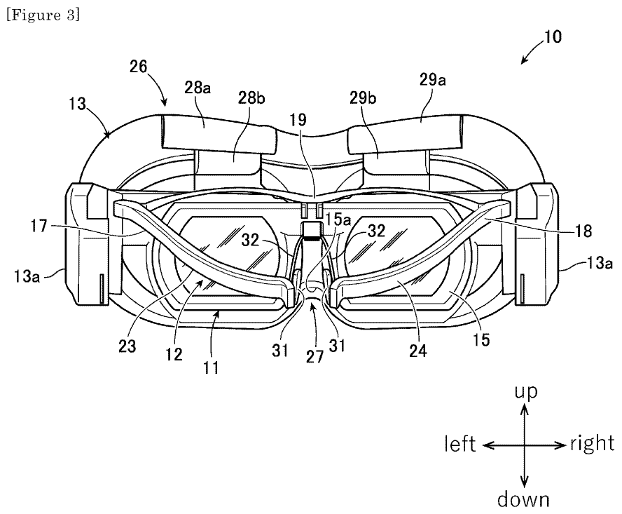

FIG. 3 is a rear view of the wearable video display device according to the embodiment. FIG. 4 is a side view of the wearable video display device according to the embodiment in a state when worn by a user. As illustrated in FIG. 3 and FIG. 4, intermediate portions, in a front-back direction, of the occipital support portions 23, 24 are curved, and the occipital support portions 23, 24 extend in a direction that gradually descends toward the rear. The function of the occipital support portions 23, 24 is discussed hereinafter.

The wearable video display device 10 additionally comprises a forehead support portion 26 provided on an upper portion of the housing 15, and a nose support portion 27 provided in a central portion, in the left-right direction, of a rear surface side of the housing 15.

As illustrated in FIG. 2, the forehead support portion 26 is provided with a left-side forehead pad 28a and a right-side forehead pad 29a which are provided separated to the left and right, sandwiching the nose support portion 27, when seen from above. A rear surface of the left-side forehead pad 28a and a rear surface of the right-side forehead pad 29a are parts that come into contact with the forehead of the user U, and are formed with a curved shape, when seen from above, to conform to the bulge of the forehead. Forming the same with a curve, in this way, makes it possible to achieve a comfortable fit to the forehead of the user U.

The left-side forehead pad 28a and the right-side forehead pad 29a are formed using a material having cushioning properties, and furthermore, in the present embodiment, are formed in a shape obtained by rolling up a thin body to enhance the cushioning properties (see FIG. 1). As illustrated in FIG. 3, the forehead support portion 26 additionally comprises a left-side linking portion 28b for linking the left-side forehead pad 28a and the housing 15, and a right-side linking portion 29b for linking the right-side forehead pad 29a and the housing 15. The linking portions 28b, 29b are each formed with an inclination in a direction that rises toward the rear, with an upper edge of the housing 15 as a base portion, and have the left-side forehead pad 28a and the right-side forehead pad 29a fixed to distal ends thereof.

The nose support portion 27 is provided on the display unit 11 in a position in the vicinity of the nose notched portion 15a of the housing 15. The nose support portion 27 comprises a left and right pair of nose pads 31, and a linking shaft 32 linking the nose pads 31 and a rear surface side of the housing 15 of the display unit 11.

Here, the total weight of the wearable video display device 10 including the components discussed hereinabove is set to 300 gf or less. The total weight does not include cables connected to the wearable video display device 10, and external devices such as communication equipment and video display control equipment that are separate from the wearable video display device 10.

Next, positional relationships and the like in a state in which the wearable video display device 10 according to the present embodiment is being worn on the head of the user U will be described mainly with reference to FIG. 4.

FIG. 4 is a drawing as seen from the right side of the user U, and therefore the configuration of the right side of the wearable video display device 10 is illustrated, but the configuration of the left side of the wearable video display device 10 and the positional relationship thereof with respect to the head of the user U are the same as those on the right side. Therefore, in FIG. 4, the reference signs of components on the left side of the wearable video display device 10 are included in parentheses together with the reference signs of the components on the right side.

In a state in which the wearable video display device 10 is being worn on the head of the user U, the left-side forehead pad 28a and the right-side forehead pad 29a of the forehead support portion 26 come into contact with a front portion of the head (forehead, above the eyebrows) of the user U. More specifically, the pads 28a, 29a are provided so as to come into contact with the supra-orbital margins of the forehead of the user U.

The left frame 17 and the right frame 18 of the frame member 12 are disposed above the ears of the user U, passing near the temples. The occipital support portions 23, 24 which form the rear regions of the left frame 17 and the right frame 18 pass above the ears of the user U and extend in a direction that gradually descends toward the rear. Further, the occipital support portions 23, 24 have a curved shape so as to approach one another when viewed from above (see FIG. 2), and thus the occipital support portions 23, 24 wrap around rearward to the back of the head and come into contact with the back of the head. More specifically, the occipital support portions 23, 24 are provided in such a way as to come into contact with the occipital bone of the back of the head of the user U.

Here, the left frame 17 and the right frame 18 have elasticity in a direction in which the rear occipital support portions 23, 24 approach one other. Further, the left frame 17 and the right frame 18 have elasticity pressing the rear ends of the arc-shaped occipital support portions 23, 24 forward against a force that causes the rear ends of the occipital support portions 23, 24 to be displaced rearward. In a state in which the wearable video display device 10 is being worn on the head of a user U, the left frame 17 and the right frame 18 move apart to the left and right in comparison with the state before being worn, and the rear ends of the occipital support portions 23, 24 deform elastically in a direction displacing the same toward the rear.

In this state, a force pressing the rear ends of the occipital support portions 23, 24 forward against the back of the head of the head is exhibited as a result of the elasticity of the left frame 17 and the right frame 18. In addition, a force resisting this force is exhibited as a force pressing backward against the supra-orbital margins of the forehead from the left-side forehead pad 28a and the right-side forehead pad 29a of the forehead support portion 26. Consequently, the forehead support portion 26 and the occipital support portions 23, 24 apply a pinching force to the head of the user U from the front and rear directions. At this time, the forehead support portion 26 accepts a supporting force acting toward the front from the supra-orbital margins of the forehead of the user U, and the occipital support portions 23, 24 accept a supporting force acting toward the rear or diagonally downward toward the rear from the back of the head of the user U.

Further, in a state in which the wearable video display device 10 is being worn on the head of the user U, the left and right pair of nose pads 31 of the nose support portion 27 are placed on the nose of the user U. In this state, the nose support portion 27 applies a downward force to the nose of the user U as a result of a portion of the total weight of the wearable video display device 10, in other words, the nose support portion 27 accepts an upward supporting force from the nose of the user U. In this way, in the present embodiment, when viewed from the side, the total weight of the wearable video display device 10 is supported with three points (illustrated by the two-dash chain line circles in FIG. 4), namely, the forehead support portion 26, the nose support portion 27, and the occipital support portions 23, 24, serving as supporting points.

Therefore, according to the present embodiment, since the abovementioned three points, including the nose support portion 27, serve as the supporting points, the points that accept the supporting forces from the head of the user U against the self weight of the wearable video display device 10 can be distributed. As a result, the pinching force acting on the head by the forehead support portion 26 and the occipital support portions 23, 24 can be reduced in comparison with a conventional HMD that sandwiches the head from the front and rear, and the fitting comfort for the user U can be improved.

Furthermore, since support is provided from below by the nose support portion 27, the three points serving as the supporting points are in a mutually spaced-apart positional relationship, making it possible for the wearable video display device 10 to be worn on the head in a balanced and stable manner. As a result, shifting of the display unit 11 with respect to the face can be suppressed while improving the fitting comfort. Furthermore, since the forehead support portion 26 and the occipital support portions 23, 24 sandwich the head from the front and back, and the total weight of the wearable video display device 10 is low, namely 300 gf or less, the force applied to the nose from the nose support portion 27 can be reduced, and this also contributes to an improved fitting comfort. The fitting comfort can be improved further by setting the total weight of the wearable video display device 10 to 230 gf or less, and can be improved even further by setting the total weight to 190 gf or less. It should be noted that if the total weight exceeds 300 gf, the fitting comfort may be compromised due to the pinching force of the forehead support portion 26 and the occipital support portions 23, 24, or due to a sense of discomfort or the like resulting from an increased force applied to the nose by the nose support portion 27, and this may make it difficult for the device to be used when worn on the head for an extended period of time, narrowing the market for the application of the device.

Further, since the occipital support portions 23, 24 are formed with a curve in the shape of a quarter arc when viewed from above, elastic deformation that changes the curvature of the occipital support portions 23, 24 is promoted, making it easier for the forehead support portion 26 and the occipital support portions 23, 24 to exhibit a pinching force on the head.

Further, since the forehead support portion 26 is configured by being divided to the left and right by the left-side forehead pad 28a and the right forehead pad 29a, the supporting forces from the head of the user U can be accepted over a wide range in the left-right direction, allowing shifting of the display unit 11 to be prevented more successfully.

It should be noted that the present invention is not limited to the abovementioned embodiment, and can be implemented with various modifications. In each of the abovementioned embodiments, sizes, shapes, directions, etc., are not limited to those illustrated in the accompanying drawings, and can be changed as appropriate within a scope in which the advantages of the present invention are exhibited. In addition, the present invention can be modified and implemented as appropriate without departing from the scope of the objective of the invention.

For example, the display unit 11 has a single housing 15 in the abovementioned embodiment, but may be configured to include a left and right pair of housings 15 corresponding to the left and right eyes of the user U.

Further, in the above embodiment, the forehead support portion 26 consists of the left-side forehead pad 28a and the right-side forehead pad 29a, which are separated to the left and right, but various modifications are possible, such as using a single pad that curves along the forehead when viewed from above.

### Industrial Applicability

The present invention relates to a wearable video display device with which the fitting comfort for the user can be improved while suppressing shifting of the display unit.

1. A wearable video display device which is worn on the head of a user and which comprises
a display unit provided with a display element and an eyepiece optical system accommodated in a housing,
a left frame and a right frame which extend in a rearward direction from the display unit and are provided independently of one another,
a forehead support portion which accepts a supporting force from a supra-orbital margin of the user's forehead, and
a nose support portion which accepts a supporting force from the user's nose, wherein:
rear regions of the left frame and the right frame serve as occipital support portions that accept a supporting force from the back of the user's head; and
a total weight of the wearable video display device is set to 300 gf or less, and the total weight is supported by the forehead support portion, the nose support portion, and the occipital support portions.

2. The wearable video display device as claimed in claim 1, wherein the forehead support portion and the occipital support portions apply a pinching force to the head of the user from front and rear directions, and the nose support portion applies a force due to a portion of the total weight onto the nose of the user.

3. The wearable video display device as claimed in claim 1 or claim 2, wherein the occipital support portions are configured by forming rear regions of the left frame and the right frame with a curved shape when viewed from above, and
a part of the forehead support portion that comes into contact with the forehead of the user is formed with a curved shape when viewed from above.

4. The wearable video display device as claimed in any one of claims 1 to 3, wherein the forehead support portion is provided divided to the left and right, sandwiching the nose support portion, when viewed from above.

5. The wearable video display device as claimed in any one of claims 1 to 4, wherein a front end side of the left frame and a front end side of the right frame are connected to a front frame, and the front frame is fitted to the display unit.
